(19) United States
(12) Patent Application Publication
(10) Pub. No.: US 2012/0235576 A1
(43) Pub. Date: Sep. 20, 2012

(54) LED Lighting Module with Co-Molded Light Sensor

(76) Inventors: Alessandro Bizzotto, Castelfranco Veneto (IT); Thomas Preuschl, Sinzing (DE); Alessandro Scordino, Dolo (Venezia) (IT)

(21) Appl. No.: 13/513,835

(22) PCT Filed: Dec. 2, 2010
(86) PCT No.: PCT/EP10/68684

§ 371 Date: Jun. 4, 2012

(30) Foreign Application Priority Data
Dec. 4, 2009 (IT) TO2009A000958

(51) Int. Cl. H05B 37/02

(52) U.S. Cl. 315/151

(57) ABSTRACT

An LED lighting module comprising: a printed circuit board (12), at least one LED (14) connected to said printed circuit board (12), a supply circuit (16) mounted on said printed circuit board (12), a protective casing (20), made of plastic, applied to said printed circuit board (12), wherein the protective casing (20) defines a light-emitting region (28) which surrounds said at least one LED (14) and a containment region (30) in which the components of said supply circuit (16) are enclosed, and a light sensor (34) arranged to receive the light emitted by said at least one LED (14) and connected to said supply circuit (16) in which said light sensor (34) is co-molded into said protective casing (20) and faces said light-emitting region (28).

### RELATED APPLICATIONS

This is a U.S. National Phase Application under 35 USC 371 of International Application PCT/EP2010/068684 filed on Dec. 2, 2010.

This application claims the priority of Italian application no. TO2009A000958 filed Dec. 4, 2009, the entire content of which is hereby incorporated by reference.

### FIELD OF THE INVENTION

The present invention is related to a lighting module with an LED in a light-emitting region of a protective casing, and a light sensor. In particular, the light sensor is molded into the protective light casing and faces the light-emitting region.

### BACKGROUND OF THE INVENTION

In traditional systems, the light sensor is positioned outside of the light-emitting region, basically because there is not enough space in the light-emitting region to allow the light sensor in the vicinity of the LEDs.

The light sensor is usually positioned in the region containing the supply circuit components. In this arrangement a light guide must be provided to connect the light sensor optically to the light-emitting region.

OBJECT AND SUMMARY OF THE INVENTION

It is an object of the invention to provide an LED lighting module with a simpler structure and fewer components. This and other objects are attained in accordance with one aspect of the present invention directed to an LED lighting module comprising: a printed circuit board; at least one LED connected to said printed circuit board; a supply circuit mounted on said printed circuit board; a protective casing, made at least partly of plastic, applied to said printed circuit board, wherein the protective casing defines a light-emitting region which surrounds said at least one LED and a containment region in which the components of said supply circuit are enclosed; and a light sensor arranged to receive the light emitted by said at least one LED and connected to said supply circuit, wherein said light sensor is co-molded into said protective casing and faces said light-emitting region.

### BRIEF DESCRIPTION OF THE DRAWINGS

The invention will now be described, purely by way of non-restrictive example, with reference to the appended drawings, in which:

FIG. 1 is a partial perspective view of an embodiment of an LED lighting module, and

FIG. 2 is a schematic section through the lighting module from FIG. 1.

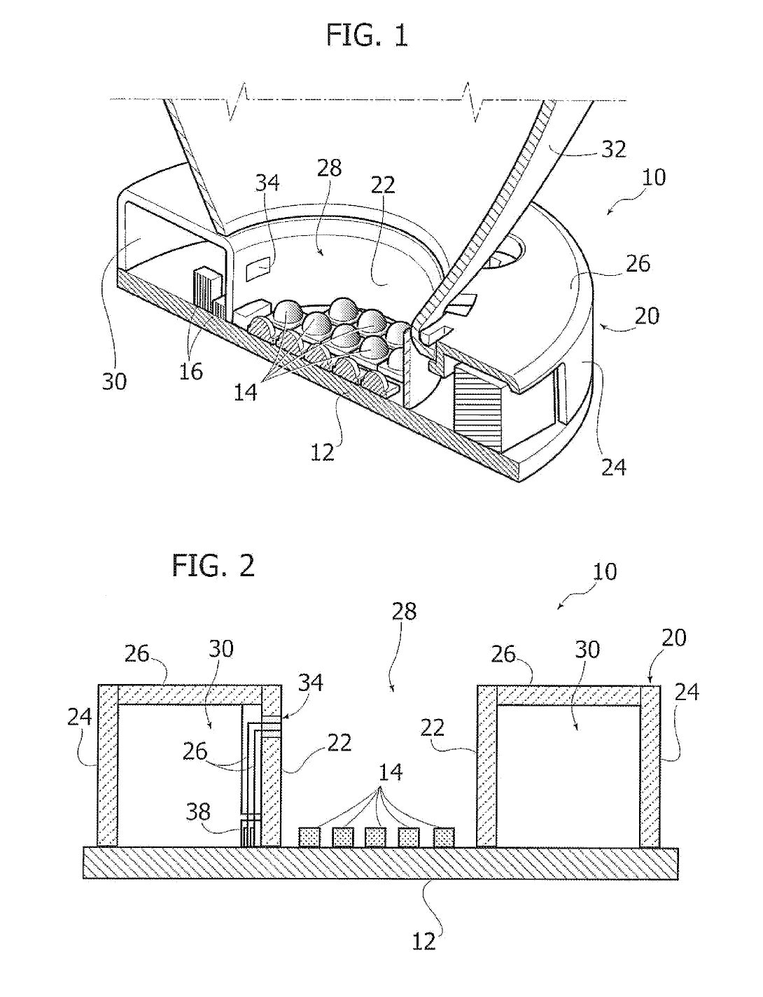

### DETAILED DESCRIPTION OF THE DRAWINGS

The following description explains various specific details designed to give an in-depth understanding of the embodiments. The embodiments can be made without one or more of the specific details, or using other methods, components, materials, etc. In other cases, known structures, materials or operations are not shown or described in detail to avoid obscuring various aspects of the embodiments.

The reference to “an embodiment” in this description means that a particular configuration, structure or feature described in relation to the embodiment is included in at least one embodiment. Consequently, the expressions such as “in an embodiment”, which may occur in various places in this description, do not necessarily refer to the same embodiment. Furthermore, particular shapes, structures or features may be combined as appropriate in one or more embodiments.

The references used here are for convenience only and therefore do not define the scope of protection or coverage of the embodiments.

In the figures, reference 10 is an LED lighting module in one embodiment of the solution described herein. The lighting module 10 comprises a printed circuit board 12 to which a plurality of LEDs 14 are connected. The module 10 is provided with a supply circuit formed by a plurality of electrical or electronic components 16 connected to the printed circuit board 12.

The LED module 10 comprises a protective casing 20 made of plastic. The protective casing 20 has an inner wall 22, an outer wall 24 and an upper wall 26. In the embodiment illustrated, the walls 22 and 24 are cylindrical walls and coaxial with each other. The outer wall 24 extends around the outer perimeter of the printed circuit board 12. The inner wall 22 surrounds the LEDs and defines a light-emitting region 28.

The part of the casing 20 which lies within the inner wall 22, the outer wall 24 and the upper wall 26 defines a containment region 30 in which the components 16 of the supply circuit are enclosed.

An optical element 32, such as a reflector, can be connected to the upper wall 26 of the protective casing 20.

In the illustrated embodiment, the LED module 10 comprises a connector 34 for electrically connecting the supply circuit 16 to an external power source. In a variant, the connector 18 could be replaced by metal contacts co-molded into the outer wall 24 of the protective casing 20, as described in a simultaneous patent application from the same Applicants.

The lighting module 10 includes a light sensor 34 which is co-molded into the protective casing 20. In the illustrated embodiment, the light sensor 34 is co-molded into the inner wall 22. The light sensor 34 directly faces the light-emitting region 28 and detects the intensity of the light radiation emitted by the LEDs 14. There is no need for additional components such as light guides or the like to connect the light sensor 34 optically to the light-emitting region 28.

The light sensor 34 has terminals 26 by which the light sensor 34 is connected electrically to the supply circuit 16.

In the embodiment shown in FIG. 2 the terminals 36 are co-molded into the inner wall 22 and their ends are connected to a connector 38 connected to the printed circuit board 12. As an alternative, the ends of the terminals 36 of the light sensor 34 could be press-fit ends, which can be pressed into the printed circuit board 12. As a further alternative, the terminals 36 may be connected electrically to the printed circuit board 12 by spring contacts.

The solution described here simplifies the structure and reduces the number of components of the lighting module. This solution also makes it possible to produce a smaller structure and thus reduces losses in optical efficiency. Not only the light sensor 34 but also other electrical or electronic components may be co-molded into the support casing 20, such as metal contacts for connecting up the supply circuit to the external power source, as indicated earlier.

Clearly, without departing from the principle of the invention, the details of construction and the embodiments may vary, even significantly, as compared with those illustrated here purely by way of non-restrictive example without thereby departing from the scope of the invention as defined in the accompanying claims.

1. An LED lighting module comprising:
a printed circuit board;
at least one LED connected to said printed circuit board;
a supply circuit mounted on said printed circuit board;
a protective casing, made at least partly of plastic, applied to said printed circuit board, wherein the protective casing defines a light-emitting region which surrounds said at least one LED and a containment region in which the components of said supply circuit are enclosed; and
a light sensor arranged to receive the light emitted by said at least one LED and connected to said supply circuit,
wherein said light sensor is co-molded into said protective casing and faces said light-emitting region.

2. The lighting module as claimed in claim 1, wherein said protective casing comprises an inner wall which delimits said light-emitting region, said light sensor being co-molded into said inner wall.

3. The lighting module as claimed in claim 2, wherein said light sensor is provided with terminals co-molded into said inner wall.

4. The lighting module as claimed in claim 3, characterized in that said terminals are connected electrically to said printed circuit board by a connector.

5. The lighting module as claimed in claim 3, wherein said terminals have press-fit ends which are pressed into said printed circuit board.

6. The lighting module as claimed in claim 3, wherein said terminals are connected electrically to the printed circuit board by spring contacts
